(19) United States
(12) Patent Application Publication
(10) Pub. No.: US 2005/0221176 A1
(43) Pub. Date: Oct. 6, 2005

(54) Prismatic-type rechargeable battery with attached lead plate

(76) Inventor: In Han Kim, Suwon-si (KR)

Correspondence Address: MCGUIREWOODS, LLP, 1750 TYSONS BLVD, SUITE 1800, MCLEAN, VA, 22102, US

(21) Appl. No.: 11/092,621

(22) Filed: Mar. 30, 2005

(30) Foreign Application Priority Data
Mar. 30, 2004 (KR) 2004-21426

(51) Int. Cl. H01M 2/04; H01M 2/08

(52) U.S. Cl. 429/175; 429/185

(57) ABSTRACT

The present invention discloses a prismatic-type rechargeable battery that comprises a bare cell that includes an electrode assembly comprising a positive electrode, a negative electrode, and a separator, a prismatic-type can that contains the electrode assembly and an electrolyte, a cap assembly that has a cap plate for covering the open upper end of the prismatic type can, and a lead plate coupled to a part of the cap plate. An electrolyte injection hole is positioned on a side of the cap plate and the lead plate has a bottom portion for covering the electrolyte injection hole. At least a part of the bottom portion is coupled to a surface of the cap plate and the bottom portion has a convex portion which corresponds to the electrolyte injection hole.

### CROSS REFERENCE TO RELATED APPLICATION

This application claims priority to and the benefit of Korean Patent Application No. 2004-21426 filed on Mar. 30, 2004, which is hereby incorporated by reference for all purposes as if fully set forth herein.

### BACKGROUND OF THE INVENTION

1. Field of the Invention

The present invention relates to a rechargeable battery, and more particularly to a prismatic-type rechargeable battery that is attached to a lead plate.

2. Description of the Prior Art

Recently, rechargeable batteries have been developed and used extensively, in part because they can be manufactured in compact sizes with the capacity for storing large amounts of energy. Typical examples of the rechargeable batteries include nickel-hydrogen (Ni-MH) batteries, lithium (Li) batteries, and lithium ion batteries.

The bare cell of a rechargeable battery is formed by first placing an electrode assembly, which is composed of positive and negative electrodes and a separator, into a can, which is made of iron, aluminum, or aluminum alloy. A cap assembly is fitted onto the can and an electrolyte is injected into it. Finally, the cap assembly is sealed to form the bare cell. Cans made of aluminum or aluminum alloys are light-weight and help to reduce the overall weight of the batteries. In addition, such batteries are resistant to corrosion even when they are used for a long time at high voltage.

In general, the bare cell of a rechargeable battery has an electrode terminal on its upper portion. The electrode terminal is insulated from its surroundings and is connected to an electrode in the electrode assembly inside the bare cell to form the positive or negative terminal of the batteries. The can itself has a polarity that is opposite to that of the electrode terminal.

The electrode terminal of sealed bare cell of the rechargeable batteries is electrically connected to a terminal of a safety apparatus, such as a positive temperature coefficient (PTC) device or a protective circuit module (PCM). The safety apparatus is connected to the positive and negative terminals and prevents dangerous situations from arising, such as damage to the battery, by interrupting the flow of current when the temperature of a battery rises drastically or the voltage thereof increases abruptly due to overcharge or over-discharge.

Generally, it is difficult to connect the electrodes of a bare cell to the electric terminals of a PCM by direct welding because of the shape and composition of the bare cell. Accordingly, a conductor structure, which is referred to as a “lead plate,” is used to connect the positive and negative electrodes of batteries to the electric terminals of a safety apparatus. The lead plate is usually made of nickel, nickel alloy, or nickel-plated stainless steel. The safety apparatus and the bare cell are placed into a separate pack while they are electrically connected to each other, or a melt resin is used to fill and coat the space between them to complete a battery pack.

More complications may occur when trying to weld a lead plate made of nickel to a can made of aluminum. Because of the non-melting properties of nickel and aluminum and the excellent conductivity of aluminum, it is very difficult to use ultra-sonic welding or resistance welding. Laser welding is an effective technique for welding the can to the lead plate. If the laser is irradiated while the lead plate is connected to a protective circuit, electrification may occur along with an electric shock, potentially deteriorating the reliability of the safety apparatuses. Hence, according to a currently used method, the lead plate is first welded to a can-type battery, and the terminal plate of the protective circuit side is then welded to the lead plate by resistance welding.

In addition, when the lead plate is directly laser welded to the bottom surface of the can, the electrolyte may leak out of the welded portion if the welding strength is not precisely controlled. The can may be as thin as 0.2 to 0.3 mm so that the batteries can have a flat shape and a reduced weight which may compromise the integrity of the can's strength. Therefore, in many cases, the lead plate is, formed on a part of the cap assembly of the can-type battery, usually on the cap plate.

Once the lead plate is connected to the cap plate through lead plate welding, the bare cell and the PCM are often placed in a mold and the gap is filled with molding resin to form a resin molding type rechargeable battery. Such a resin molding type rechargeable battery is advantageous in that it has a smooth appearance compared to when a separate case for a hard pack is used. It also has reduced thickness since no case is necessary and a process for putting it in a case is also unnecessary.

FIG. 1 is a lateral sectional view of the upper portion of a bare cell that illustrates the problem that occurs when a lead plate is welded to the side of a cap plate of a bare cell of a Prismatic type rechargeable battery according to the prior art.

Referring to FIG. 1, an electrode assembly 12, which is formed by laminating and winding negative and positive electrodes 15 and 13 and a separator 14, is inserted into a can 11, and a cap assembly is coupled to the open upper portion of the can. The cap assembly has a positive terminal called a cap plate 110 as a main body and a negative terminal 130 formed in the central hole of the cap plate 110 via an insulating gasket 120. The cap plate 110 has an electrolyte injection hole 112 formed on a side thereof. The cap plate 110 may also have a safety vent (not shown) positioned on the other side thereof. The electrolyte injection hole makes it possible to inject an electrolyte into the can 11 after it is topped with the cap assembly.

After the injection, the electrolyte injection hole 112 is sealed by a plug 160, which is formed by press-fitting an aluminum ball. However, in such a conventional resin molding type rechargeable battery wherein a minute gap is likely to exist between the electrolyte injection hole 112 and the plug 160. Therefore, laser welding must be performed between the plug and the cap plate around the plug in order to prevent the electrolyte from leaking through the gap. The leakage of the electrolyte may also be prevented by applying a liquid resin (or resin droplets) on the plug 160 and curing it by light or heat to form a resin plugging member 250. The resin plugging member 250 or the plug 160 inevitably protrudes out of a surface of the cap plate, due to the nature of the method used to form them.

The lead plate 210 includes a bottom portion 211, with a predetermined area for surface-surface coupling with the cap plate 110 of the bare cell and a wall portion 213 that protrudes vertically toward the PCM from the bottom portion 211 for coupling with the electric terminal of the PCM. Because of its size, a part of the lead plate 210 is superimposed on the electrolyte injection hole 112. When the bottom portion 211 of the lead plate is welded to the cap plate 110, the plug 160 or the resin plugging member 250, which protrudes out of the electrolyte injection hole 112, the bottom portion 211 of the lead plate is made to float on a surface of the cap plate 110, as shown in FIG. 1 in a somewhat exaggerated manner. This configuration interferes with the welding process and, even when the welding can be performed, it weakens the bond that is formed.

The lead plate acts as a conducting path for connecting the cap plate to the connection terminal of the PCM. The lead plate is inserted into the molding resin portion which couples the PCM and the bare cell to each other in the resin molding type rechargeable battery to firmly retain the bare cell. If the welded bond between the lead plate and the cap plate is insufficiently strong, the lead plate cannot accomplish the above functions. As a result, the mechanical strength or the electric connection of a finished rechargeable battery deteriorates.

### SUMMARY OF THE INVENTION

The present invention has been developed to solve the above-mentioned problems occurring in the prior art. The present invention provides a prismatic type rechargeable battery that includes a lead plate where the bottom portion of the lead plate and a surface of a cap plate can easily be welded together to ensure a strong coupling between them.

The present invention also provides a prismatic-type rechargeable battery that includes a lead plate where a protrusion on the surface of a cap plate is accomodated to prevent any floating or large gaps between the lead plate and the cap plate.

Additional features of the invention will be set forth in the description which follows, and in part will be apparent from the description, or may be learned by practice of the invention.

The present invention discloses a prismatic type rechargeable battery comprising a bare cell including an electrode assembly composed of positive and negative electrodes and a separator and a prismatic type that contains the electrode assembly. The battery also includes an electrolyte, and a cap assembly that has a cap plate for finishing the open upper end of the prismatic type can and a lead plate coupled to a part of the cap plate. The cap plate has an electrolyte injection hole that is positioned on its side. The lead plate has a bottom portion that covers the electrolyte injection hole, where at least a part of the bottom portion is coupled to a surface of the cap plate, and the bottom portion contains a convex portion which corresponds to the electrolyte injection hole.

It is to be understood that both the foregoing general description and the following detailed description are exemplary and explanatory and are intended to provide further explanation of the invention as claimed.

### BRIEF DESCRIPTION OF THE DRAWINGS

The above and other objects, features and advantages of the present invention will be more apparent from the following detailed description taken in conjunction with the accompanying drawings.

The accompanying drawings, which are included to provide a further understanding of the invention and are incorporated in and constitute a part of this specification, illustrate embodiments of the invention and together with the description serve to explain the principles of the invention.

FIG. 1 is a lateral sectional view of the upper portion of a bare cell that illustrates the problem that occurs when a lead plate is coupled by welding to a side of a cap plate of a bare cell of a prismatic type rechargeable battery according to the prior art.

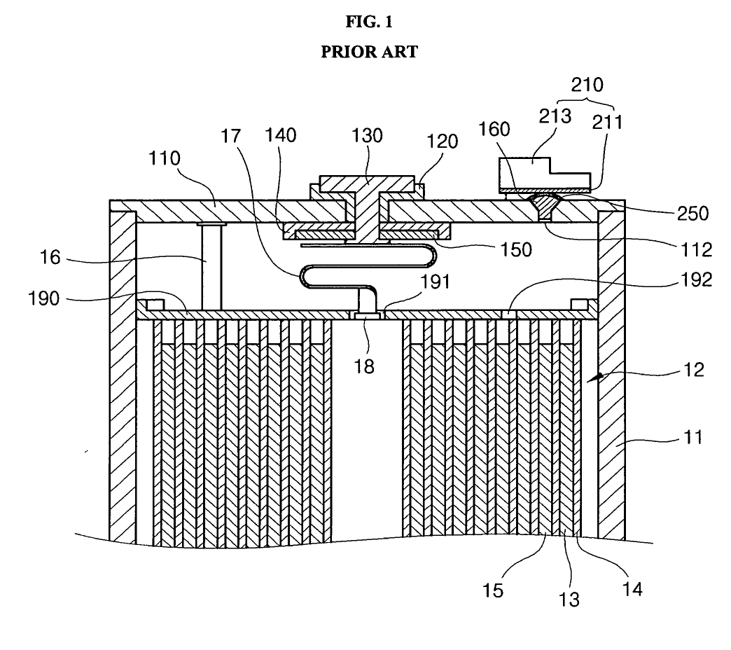

FIG. 2 is an exploded perspective view that shows a prismatic type rechargeable battery according to an exemplary embodiment of the present invention where a PCM and a bare cell are coupled to each other before they are coupled by a molding resin.

FIG. 3 is a partial perspective view that shows a bare cell and a lead plate that are coupled to each other according to an exemplary embodiment of the present invention.

FIG. 4 is a front sectional view that shows a prismatic type rechargeable battery according to an exemplary embodiment of the present invention, wherein a bare cell and a lead plate are coupled to each other.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components.

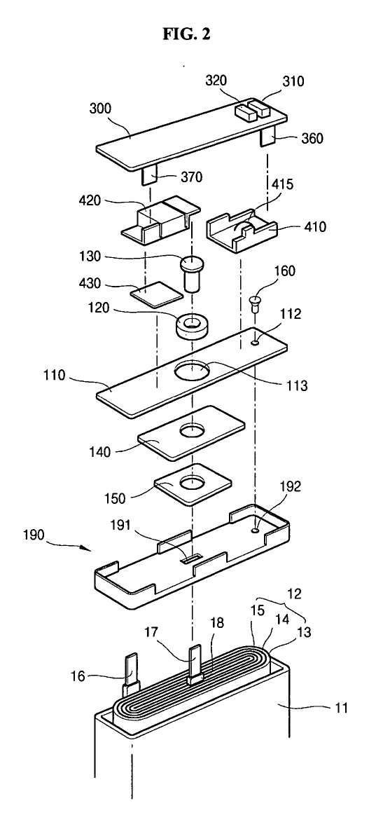

FIG. 2 depicts a lithium pack battery that has a bare cell which includes a can 11, a electrode assembly 12 contained in the can 11, and a cap assembly coupled to the open upper end of the can 11 for sealing it.

The electrode assembly 12 is formed by winding a positive electrode 13, a separator 14, and a negative electrode 15 from a thin plate or a film shape into an eddy shape. Insulating tapes 18 are wound about respective boundary portions wherein positive and negative leads 16 and 17 are led out of the electrode assembly 12, in order to prevent a short circuit between the two electrodes 13 and 15. The prismatic type can 11 is generally made of aluminum or aluminum alloy and is in the shape of a cuboid. The can 11 contains the electrode assembly 12 through its open upper end as well as an electrolyte. The cap assembly has a cap plate 110 which plays the role of the positive terminal of the bare cell.

The cap assembly has a flat plate-shaped cap plate 110, which has a size and a shape corresponding to the open upper end of the can 11, and a terminal through-hole 113 formed in its central portion, so that the negative terminal 130 can pass through. A circular gasket 120 is positioned on the outer portion of the negative terminal 130 to electrically insulate the negative terminal 130 from the cap plate 110. An insulating plate 140 is placed on the lower surface of the cap plate 110. The insulating plate 140 has a terminal plate 150 positioned on its lower surface for connection with the negative terminal 130. The cap plate 110 has a positive lead 16 welded to its lower surface, and its negative terminal 130 has a negative lead 17 welded to its lower end.

Meanwhile, an insulating case 190 may be positioned to cover the upper end of the electrode assembly 12. The insulating case has a lead through-hole 191 and an electrolyte through-hole 192 formed thereon. The cap plate 110 may have an electrolyte injection hole 112 formed on its side about the negative terminal and a safety vent (not shown) formed on its other side. The electrolyte injection hole 112 is provided with a plug 160 that seals it after an electrolyte is injected. A resin plugging member (not shown) is placed above the plug 160. The peripheral portion of the cap plate 110 is coupled by welding to the upper end of the lateral wall of the can 11.

The PCM 300 has a circuit portion and connection terminals 360 and 370 positioned on its inner surface, which is opposite to the surface that has external terminals 310 and 320 formed thereon. The connection terminals 360 and 370 may be coupled by resistance spot welding to lead plates 410 and 420, which are coupled to the bare cell. The lead plate 420, which is positioned between the PCM and the negative terminal, may have a breaker coupled thereto. An insulating plate 430 made of a double-faced tape, for example, is used to insulate the lead plate 420, which is connected to the negative terminal 130, from the cap plate 110. If the cap plate 110 is provided with a safety vent, the insulating plate 430 can couple the lead plate 420 thereto while protecting the safety vent.

The lead plate 410, which is positioned above the plug 160, is coupled to a surface of the cap plate at a surface of the bottom portion thereof. The bottom portion of the lead plate 410, which is generally coupled to the cap plate, has an approximately rectangular shape and is provided with a wall portion on at least a part of the peripheral edge thereof, which protrudes vertically relative to the surface of the cap plate. In the present invention, the lead plate 410 has a convex portion 415 formed on the bottom portion thereof, which corresponds to the electrolyte injection hole 112, as in the case of the plug 160 or the resin plugging member.

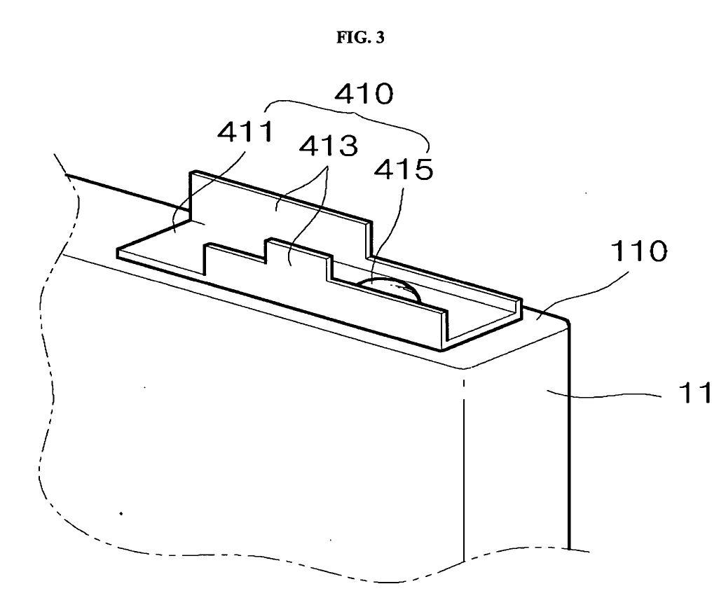

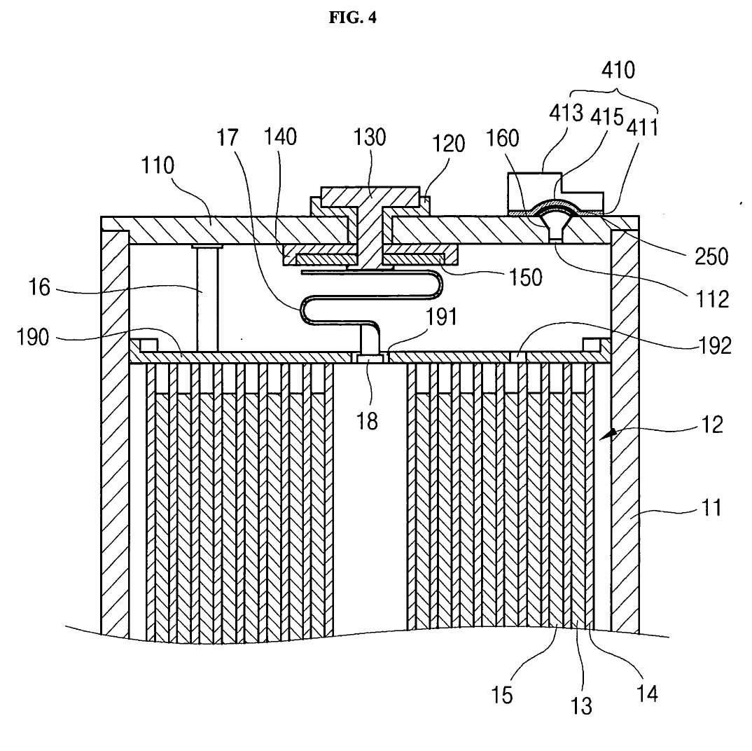

Referring to FIG. 3 and FIG. 4, a part of the bottom portion of the lead plate, which corresponds to the convex portion 415, is spaced from the cap plate 110, and a space is formed between the convexity 415 and the cap plate 110. The plug 160 or the resin plugging member 250, which protrudes out of a surface of the cap plate 110 from the electrolyte injection hole 112 of the cap plate 110, is contained in the space formed by the convexity 415.

Therefore, in contrast to the prior art, the bottom portion 411 of the lead plate can be fastened to the surface of the cap plate, except for where the convex portion 415 is formed. This improves the welding strength between the lead plate and the cap plate and stabilizes the mechanical and electric connections of the lead plate to the bare cell.

The convex portion 415 may have various shapes, including a square, a semi-sphere, or a moderately curved surface, but preferably has a size and a shape corresponding to the conventional shape of the plug 160 or the resin plugging member 250, which protrudes out of the cap plate 110. If the size of the convex portion becomes too large, the area of the bottom portion 411 of the lead plate that is in contact with the cap plate, is reduced. This may make the welding difficult and degrade the welding strength.

The convex portion can be formed by various methods, including pressing. For example, the whole lead plate is cut into a shape and is bent to form the bottom portion and the wall portion. A part of the bottom portion is then pressed by a press that has a semi-spherical jig to form the convex portion. The convex portion can also be formed concurrently with pressing the wall portion. Alternatively, the whole lead plate can be cast by pouring a material into a mold, which has the same shape as the convex portion.

The lead plate is typically made of nickel or nickel alloy material. The bottom of the lead plate can be welded to the cap plate by various laser welding methods, except for where the convex portion is formed. The depth of the laser welding of the lead plate is generally 0.15 to 0.4 mm taking into consideration the thicknesses of the lead plate and the cap plate as well as necessary welding strength.

The thickness of the lead plate is preferably in the range of 0.05 to 0.45 mm and depends on the thickness of the can and welding convenience. In the case of a pack battery which is formed by filling the space between a battery can sealed by a cap assembly and a PCM, a thick lead plate can advantageously act as a support when the battery is twisted or bent. This increases the degree of resistance against external forces.

The welding can be performed using various methods. For example, spot welding may be evenly performed on the bottom portion, but it is preferred to increase the welding strength by line welding. Line welding can be performed using various techniques depending on the size and shape of the bottom portion of the lead plate, including forming a closed loop (e.g., a circle) and a curved line (e.g., a straight line, an L-shaped line, and a U-shaped line).

Line welding can be performed along the periphery of the bottom portion of the lead plate. This technique, where the welding is performed directly at the contact portion between the lead plate and the cap plate, is more advantageous for adjusting the welding strength and reducing faults as compared with the case where welding is performed from above the bottom portion.

After the welding process of the lead plate is complete, a PCM and other battery components are connected to the battery. The lead plate may act as the positive electrode and the electrode terminal may act as the negative electrode. The structure and polarity of the electrodes may vary in different embodiments. Depending on the type and shape of the PCM and the battery components, the battery may be put into a separate sheath body. Alternatively, the battery may be molded into a pack battery from filling the space between the PCM and the cap plate with a low-temperature molding resin in a hot melt process, or by applying an overall resin coating.

As mentioned above, the present invention provides a secure bond strength in the welded portion between the lead plate and the cap assembly. This prevents the lead plate from being separated from the cap assembly easily when the battery pack is subject to an external force or during manufacturing subsequent to the process welding of the lead plate. It also allows a stable electric connection between battery component parts.

In addition, this method allows the laser output to be adjusted easily, which is necessary for welding, because it allows stable welding while the lead plate is fastened to the cap plate.

Although a preferred embodiment of the present invention has been described for illustrative purposes, those skilled in the art will appreciate that various modifications, additions and substitutions are possible, without departing from the scope and spirit of the invention as disclosed in the accompanying claims. Thus, it is intended that the present invention cover the modifications and variations of this invention provided they come within the scope of the appended claims and their equivalents.

1. A prismatic-type rechargeable battery, comprising:
a bare cell including an electrode assembly comprising a positive electrode, a negative electrode, and a separator, a prismatic type can that contains the electrode assembly and an electrolyte, and a cap assembly that has a cap plate that covers the open upper end of the prismatic type can; and
a lead plate coupled to a part of the cap plate,
wherein an electrolyte injection hole is positioned on a side of the cap plate,
wherein the lead plate has a bottom portion that covers the electrolyte injection hole, at least a part of the bottom portion being coupled to a surface of the cap plate, and
wherein the bottom portion has a convex portion formed on a part thereof which corresponds to the electrolyte injection hole.

2. The prismatic-type rechargeable battery of claim 1, wherein the lead plate has a wall portion protruding upward from the bottom portion that couples with other electronic components.

3. The prismatic-type rechargeable battery of claim 1,
wherein the electrolyte injection hole is covered with a plug formed by aluminum press-fit, and a resin plugging member, and
wherein the convex portion is a surface of the bottom portion facing the bare cell that is configured as a curved surface that conforms to the shape of the resin plugging member.

4. The prismatic-type rechargeable battery of claim 1, wherein the convex portion is formed as a square-type convex portion.

5. The prismatic-type rechargeable battery of claim 1, wherein the bottom portion has a line-welded portion on the bottom portion surface, which has the shape of a closed loop or a straight line, and is coupled to the cap plate.

6. The prismatic-type rechargeable battery of claim 1, wherein the bottom portion is line-welded at the peripheral portion and is coupled to the cap plate.

7. The prismatic-type rechargeable battery of claim 1, wherein the convex portion is formed by a pressing method.
